(19) United States
(12) Patent Application Publication
(10) Pub. No.: US 2011/0155948 A1
(43) Pub. Date: Jun. 30, 2011

(54) Polyamide Based Resin Composition Having Excellent Whiteness, Thermal Conductivity, and Extruding Moldability

(75) Inventors: Han Namkung, Uiwang-si (KR); Chan Gyun Shin, Uiwang-si (KR); Young Sik Ryu, Uiwang-si (KR); Bum Seok Youn, Uiwang-si (KR); Jong Yeun Kim, Uiwang-si (KR); Jong Cheol Lim, Uiwang-si (KR)

(73) Assignee: CHEIL INDUSTRIES INC., Gumi-si (KR)

(21) Appl. No.: 12/981,669

(22) Filed: Dec. 30, 2010

(30) Foreign Application Priority Data
Dec. 31, 2009 (KR) 10-2009-0136120

(51) Int. Cl. C09K 5/00

(52) U.S. Cl. 252/74; 252/73

(57) ABSTRACT

The present invention provides a polyamide resin composition that can have good whiteness, thermal conductivity and extrusion molding properties, which includes (A) polyamide resin; (B) heat conductive filler; (C) filler; and (D) thermoplastic resin which is miscible with the polyamide resin and has a weight average molecular weight of about 500,000 to about 5,000,000.

### CROSS-REFERENCE TO RELATED APPLICATIONS

This application claims priority from Korea Patent Application No. 2009-0136120, filed on Dec. 31, 2009, in the Korean Intellectual Property Office, the disclosure of which is incorporated herein by reference in its entirety.

### FIELD OF THE INVENTION

The present invention relates to a polyamide resin composition and a method for preparing the polyamide resin composition that can have excellent whiteness, thermal conductivity and extruding moldability.

### BACKGROUND OF THE INVENTION

The history of nylon as an engineering plastic is close to 40 years, yet there still there remains a high demand for the same. The continuing demand for nylon is due at least in part to the wide variety of types of nylon, such as nylon 6, nylon 6,6, nylon 6,10, nylon 6,12, nylon 11, nylon 12, and the like, and combinations and blends thereof, each of which has useful properties and various performance characteristics.

The mechanical properties and heat resistance of nylon can be improved by adding inorganic reinforcing material such as glass fiber. Such reinforced nylon compositions can be used in applications such as structural materials and interior and exterior materials for cars.

Recently, there has been increased focus on nylon resin as a material for components used in light emitting diodes (LEDs), such as reflectors, reflector cups, scramblers and housings for LEDs, because nylon has excellent energy efficiency and energy lifespan.

Reflector materials for LEDs currently available in the market generally have heat resistance and high whiteness. The thermal conductivity of many reflector materials is around 0.1˜0.2 W/m-K which is as low as the thermal conductivity of conventional high molecular weight resins. Accordingly, a metal thin film with high conductivity had been conventionally inserted in order to eliminate heat within a LED reflector. However, there is no material currently available that radiates heat by increasing thermal conductivity of the reflector per se.

### SUMMARY OF THE INVENTION

The present invention provides a polyamide resin composition that can have excellent whiteness as well as thermal conductivity and a method for preparing the polyamide resin composition. The present invention further provides a polyamide resin composition that can have excellent extruding moldability and a method for preparing the polyamide resin composition.

The polyamide resin composition can accordingly be used as a material for a part for a LED, such as an integrated part including a reflector and a heat removal plate.

The polyamide resin composition of the invention includes (A) polyamide resin, (B) heat conductive filler, (C) filler (which is different from the heat conductive filler) and (D) a thermoplastic resin which is miscible with the polyamide resin and has a weight average molecular weight of about 500,000 to about 5,000,000.

In exemplary embodiments of the present invention, the thermoplastic resin which is miscible with the polyamide resin and has a weight average molecular weight of about 500,000 to about 5,000,000 (D) includes acrylic resin, sulfide resin, polyolefin resin, or a combination thereof.

In exemplary embodiments of the present invention, the polyamide resin composition includes about 10 to about 80% by weight of the (A) polyamide resin, about 5 to about 55% by weight of the (B) heat conductive filler, about 5 to about 30% by weight of the (C) filler, and about 5 to about 80% by weight of the (D) thermoplastic resin which is miscible with the polyamide resin and has a weight average molecular weight of about 500,000 to about 5,000,000.

In exemplary embodiments of the present invention, the polyamide resin composition further includes (E) white pigment. In exemplary embodiments of the present invention, the polyamide resin composition can include (E) the white pigment in an amount of about 5 to about 30 parts by weight, based on 100 parts by weight of the polyamide resin composition including about 10 to about 80% by weight of the (A) polyamide resin, about 5 to about 55% by weight of the (B) heat conductive filler, about 5 to about 30% by weight of the (C) filler, and about 5 to about 80% by weight of the (D) thermoplastic resin which is miscible with the polyamide resin and has a weight average molecular weight of about 500,000 to about 5,000,000.

In exemplary embodiments of the present invention, the initial whiteness index of the polyamide resin composition is more than about 89.

In exemplary embodiments of the present invention, the thermal conductivity of the polyamide resin composition is more than about 3.0 W/mK.

In exemplary embodiments of the present invention, the melt tensile strength of the polyamide resin composition is about 50 to about 150 cN at a tensile velocity of 100 mm/s.

The present invention also provides a method for producing a polyamide resin composition which can have a melt tensile strength of 50 to about 150 cN (100 mm/s of tensile velocity) as well as excellent thermal conductivity and whiteness. The method of the invention includes mixing (A) polyamide resin, (B) heat conductive filler, (C) filler, and (D) thermoplastic resin which is miscible with the polyamide resin and has a weight average molecular weight of about 500,000 to about 5,000,000

In exemplary embodiments of the method, the (D) thermoplastic resin which is miscible with the polyamide resin and has a weight average molecular weight of about 500,000 to about 5,000,000 comprises acrylic resin, sulfide resin, polyolefin resin, or a combination thereof.

In exemplary embodiments of the invention, the method for producing a polyamide resin composition includes mixing about 10 to about 80% by weight of the (A) polyamide resin, about 5 to about 55% by weight of the (B) heat conductive filler, about 5 to about 30% by weight of the (C) filler, and about 5 to about 80% by weight of the (D) thermoplastic resin which is miscible with the polyamide resin and has a weight average molecular weight of about 500,000 to about 5,000,000.

In exemplary embodiments of the invention, the method for producing a polyamide resin composition further includes adding (E) white pigment. In exemplary embodiments of the invention, the method for producing a polyamide resin composition includes adding the (E) white pigment in an amount of about 5 to about 30 parts by weight, based on 100 parts by weight of the polyamide resin composition including about 10 to about 80% by weight of the (A) polyamide resin, about 5 to about 55% by weight of the (B) heat conductive filler, about 5 to about 30% by weight of the (C) filler, and about 5 to about 80% by weight of the (D) thermoplastic resin which is miscible with the polyamide resin and has a weight average molecular weight of about 500,000 to about 5,000,000.

The present invention further provides an article prepared from the polyamide resin composition. In exemplary embodiments of the present invention, the article is a heat removal plate which can be used as a reflector in a LED. In another exemplary embodiment of the present invention, the article is an integrated part for a LED which includes a reflector and a heat removal plate.

### DETAILED DESCRIPTION OF THE INVENTION

The present invention will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

Polyamide Resin Composition

The present invention provides a polyamide resin composition including (A) polyamide resin, (B) heat conductive filler, (C) filler and (D) thermoplastic resin which is miscible with the polyamide resin and has a weight average molecular weight of about 500,000 to about 5,000,000.

In an exemplary embodiment of the invention, the polyamide resin composition further includes (E) white pigment.

(A) Polyamide Resin

The polyamide resin of the present invention is prepared by polymerizing dicarboxylic acid and diamine.

Exemplary dicarboxylic acids may include without limitation aromatic carboxylic acids such as terephthalic acid, isophthalic acid, 2-methyl terepthalic acid, naphthalene dicarboxylic acid, phthalic anhydride, trimellitic acid, pyromellitic acid, trimellitic anhydride, pyromellitic anhydride, and the like; alkane carboxylic acids such asoxalic acid, malonic acid, succinic acid, glutaric acid, adipic acid, pimelic acid and the like; and combinations thereof.

Exemplary diamines may include without limitation C5-C30 aromatic diamines, C1-C30 aliphatic diamines, C5-C30 alicyclic diamines, and combinations thereof.

Specific examples of aliphatic amines having 1 to 30 carbon atoms include without limitation 2-methyl-1,5-diaminopentane, 2-methyl-1,6-diaminohexane, 2-methyl-1,7-diaminoheptane, 2-methyl-1,8-diaminooctane, 2-methyl-1,9-diaminononane, 2-methyl-1,10-diaminodecane, 2-methyl-1,1′-diaminoundecane, and the like, and combinations thereof.

Specific examples of alicyclic diamines having 5 to 30 carbon atoms include without limitation 1,3-diaminocyclohexane, 1,4-diaminocyclohexane, 1,3-bis(aminomethyl)cyclohexane, 1,4-bis(aminomethyl)cyclohexane, isophoronediamine, piperazine, 2,5-dimethylpiperazine, bis(4-aminocyclohexyl)methane, bis(4-aminocyclohexyl)propane, 4,4′-diamino-3,3′-dimethyldicyclohexylpropane, 4,4′-diamino-3,3′-dimethyldicyclohexylmethane, 4,4′-diamino-3,3′-dimethyl-5,5′-dimethyldicyclohexylmethane, 4,4′-diamino-3,3′-dimethyl-5,5′-dimethyldicyclohexylpropane, α,α′-bis(4-aminocyclohexyl)-p-diisopropylbenzene, α,α′-bis(4-aminocyclohexyl)-m-diisopropylbenzene, α,α′-bis(4-aminocyclohexyl)-1,4-cyclohexane, α,α′-bis(4-aminocyclohexyl)-1,3-cyclohexane, and the like, and combinations thereof.

Specific examples of aromatic diamines having 5 to 30 carbon atoms include without limitation p- or m-xylene diamine, and the like, and combinations thereof.

In an exemplary embodiment, the polyamide resin (A) includes a modified polyamide based thermoplastic resin with a main chain including a benzene ring, which may be prepared by condensation polymerization of a dicarboxylic acid monomer including about 10 to about 100% by weight of an aromatic dicarboxylic acid with an aliphatic and/or alicyclic diamine. In this embodiment of the invention the aromatic dicarboxylic acid may include terephthalic acid (TPA) represented by Formula 1a below, isophthalic acid (IPA) represented by Formula 1b below, or a combination thereof.

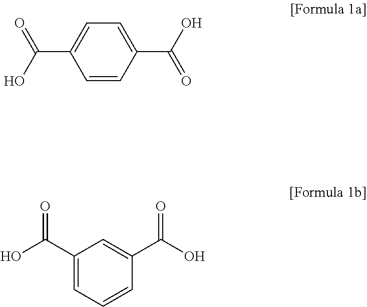

The aliphatic and/or alicyclic diamine above may be represented by NRR′, wherein R and R′ are each independently H or substituted or non-substituted C4-C20 alkyl. As used herein, unless otherwise defined, the term “substituted” refers to a group in which a hydrogen is substituted with halogen (F, Cl, Br, I), hydroxy, nitro, cyano, amino, carboxyl, C1 to C20 alkyl, C2 to C20 alkenyl, C2 to C20 alkynyl, C1 to C20 alkoxy, C6 to C30 aryl, C6 to C30 aryloxy, C3 to C30 cycloalkyl, C3 to C30 cycloalkenyl, C3 to C30 cycloalkynyl, or a combination thereof.

A non-limiting example of an aliphatic and/or alicyclic diamine is hexamethylenediamine.

In an exemplary embodiment, the modified polyamide based thermoplastic resin is nylon 6T, which is prepared by condensation polymerization of hexamethylenediamine and terephthalic acid and is represented by Formula 2 below.

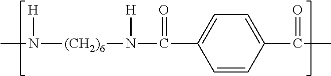

In exemplary embodiments of the present invention, the modified polyamide based thermoplastic resin can be further mixed with an aliphatic polyamide such as nylon 6, nylon 66 and the like.

Specific examples of the modified polyamide based thermoplastic resin include without limitation nylon 6T, nylon 9T, nylon 10T, nylon 11T, nylon 12T, nylon 6T/66, nylon 10T/1012, nylon 6I/66, nylon 6T/6I/66, and the like, and combinations thereof.

The polyamide resin composition of the invention includes the polyamide resin (A) in an amount of about 10 to about 80% by weight, based on the total weight of (A), (B), (C) and (D). In some embodiments, the polyamide resin composition may include the polyamide resin (A) in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80% by weight. Further, according to some embodiments of the present invention, the amount of the polyamide resin (A) can be in a range from about any of the foregoing amounts to about any other of the foregoing amounts.

(B) Heat Conductive Filler

Examples of the heat conductive filler used in the present invention can include without limitation boron nitride, aluminum oxide, boron carbide, calcium fluoride, aluminum nitride, and the like, and combinations thereof. The heat conductive filler is used to enhance conductivity of the polyamide resin composition.

A reflector for a LED can be used under conditions of about 180° C. resulting from heat produced in the process of converting electric energy into light and, accordingly, the produced heat needs to be continuously radiated outward. Thus, a metal thin film with high conductivity has been conventionally inserted in order to eliminate heat within a LED reflector.

In contrast, in the present invention, heat conductive filler is added to the polyamide based composition so that a LED component such as a reflector including the same exhibits increased thermal conductivity and can remove heat efficiently without an additional metal plate.

In exemplary embodiments, the heat conductive filler is boron nitride having a high whiteness property. This embodiment can provide high whiteness and thermal conductivity simultaneously without using a white pigment

The polyamide resin composition of the invention includes the heat conductive filler (B) in an amount of about 5 to about 55% by weight, based on the total weight of (A), (B), (C) and (D). In some embodiments, the polyamide resin composition may include the heat conductive filler (B) in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55% by weight. Further, according to some embodiments of the present invention, the amount of the heat conductive filler (B) can be in a range from about any of the foregoing amounts to about any other of the foregoing amounts.

(C) Filler

The polyamide resin composition of the present invention can include filler (which is different from the heat conductive filler described herein) in various forms, such as but not limited to fiber, powder, particle, flake, needle, cloth, mat, and the like, and combinations thereof, in order to improve mechanical properties, heat resistance and dimensional stability of the resin composition.

In the present invention, any conventional organic or inorganic filler can be used. Exemplary filler includes without limitation carbon fibers, glass fibers, boron fibers, glass beads, glass fibers, carbon black, diatomaceous earth, clay, kaolin, talc, mica, calcium carbonate, filler in the form of needles, and the like, and combinations thereof. Examples of tiller in needle form include without limitation wollastonite, potassium titanate whiskers, aluminum boric acid whiskers, zinc oxide whiskers, calcium whiskers and the like, and combinations thereof. In exemplary embodiments, glass fiber can be used, which can provide high impact strength and lower cost. In other exemplary embodiments, filler in the form of needles can be used, which can provide an article with excellent surface smoothness. In other exemplary embodiments of the invention, glass fiber, wollastonite, potassium titanate whiskers and/or aluminum boric acid whiskers can be used to provide high whiteness.

The polyamide resin composition of the invention includes the filler (C) in an amount of about 5 to about 30% by weight, based on the total weight of (A), (B), (C) and (D). In some embodiments, the polyamide resin composition may include the filler (C) in an amount of about 5, 6, 7, 8, 9, 10, 11, 12, 13, 14, 15, 16, 17, 18, 19, 20, 21, 22, 23, 24, 25, 26, 27, 28, 29, or 30% by weight. Further, according to some embodiments of the present invention, the amount of the filler (C) can be in a range from about any of the foregoing amounts to about any other of the foregoing amounts.

(D) Thermoplastic Resin which is Miscible with the Polyamide Resin and has a Weight Average Molecular Weight of about 500,000 to about 5,000,000

The polyamide resin composition of the present invention further includes a thermoplastic resin which is miscible with the polyamide resin and has a weight average molecular weight of about 500,000 to about 5,000,000. The thermoplastic resin which is miscible with the polyamide resin and has a weight average molecular weight of about 500,000 to about 5,000,000 can provide excellent extrusion molding properties to the polyamide resin composition.

Polyamide resin generally has excellent physical impact strength; however, it can be easily broken when force is applied and may not agglomerate well while extruding. Thus, the inventors have discovered that when a thermoplastic resin has a weight average molecular weight of about 500,000 to about 5,000,000 is mixed with the polyamide resin, melt tensile strength of the polyamide resin composition increases and, thereby, extrusion molding properties such as agglomeration can be improved.

Also, the thermoplastic resin for improving the extrusion molding properties of the polyamide resin should have excellent compatibility with polyamide resin as well as the above condition of weight average molecular weight.

Examples of thermoplastic resins that have a weight average molecular weight of about 500,000 to about 5,000,000 and which are miscible with polyamide resin include acrylic resin, sulfide resin, polyolefin resin and the like, and combinations thereof.

The acrylic resin may be a conventionally available resin as known to the skilled artisan. Exemplary acrylic resins can include without limitation polymers of a single type of (meth)acrylic monomer, a copolymer of one or more kinds of (meth)acrylic monomer(s), or a combination thereof. Examples of the (meth)acrylic monomer may include without limitation methyl methacrylate, ethyl methacrylate, n-propyl methacylate, n-butyl methacylate, phenyl methacrylate, benzyl methacrylate, hexyl methacrylate, cyclohexyl methacrylate, phenoxy methacrylate, phenoxyethyl methacrylate, methyl acrylate, ethyl acrylate, propyl acrylate, butyl acrylate, 2-ethyl-hexyl acrylate, 2-ethyl-hexyl-methacrylate and the like. In exemplary embodiments, the acrylic resin can include poly(methyl methacrylate) (PMMA) resin.

The sulfide resin may be a conventionally available resin as known to the skilled artisan. Exemplary sulfide resins can include without limitation polyarylene sulfide resins such as polyphenylene sulfide resins. The polyphenylene sulfide resin can include about 70 mole % or more, for example about 80 mole % or more, of a repeating unit represented by the following Formula 1:

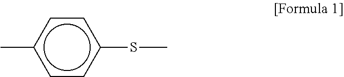

The polyphenylene sulfide resin may include at least one other repeating unit selected from the following Formulas 2 to 9, in addition to the repeating unit of the Formula 1. The polyphenylene sulfide resin can include the repeating units of Formulas 2 to 9 in an amount of less than about 50 mole %, for example less than about 30 mole %.

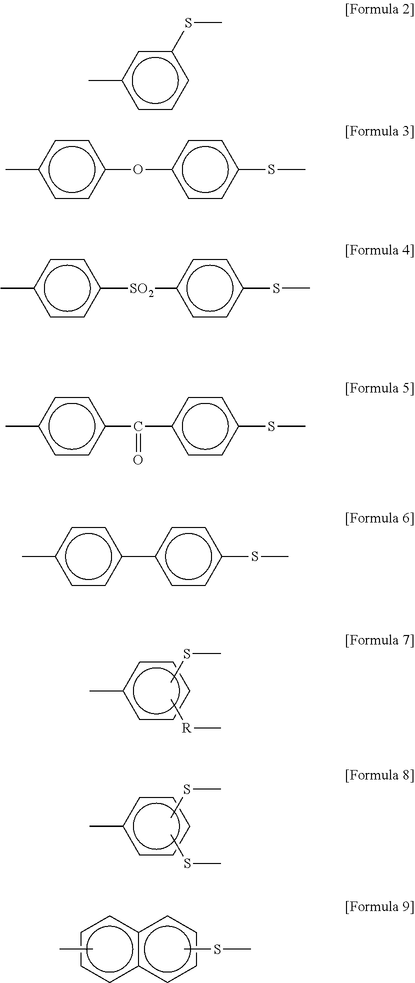

In Formula 7, R is a C1-C20 alkyl group, a nitro group, a phenyl group, a C1-C20 alkoxy group, a carboxyl group, or a metal carboxylate group.

The polyolefin resin may be a conventionally available resin as known to the skilled artisan. Exemplary polyolefin resins can include without limitation homopolymers and/or copolymers of an olefin such as ethylene, propylene, butane, and the like, and combinations thereof, as well as copolymers of an olefin and a monomer copolymerizable with the olefin. Specific examples of the polyolefin resin include without limitation polyethylene, such as low density polyethylene (LDPE), high density polyethylene (HDPE), ultra-high density polyethylene (UHDPE), and the like, polypropylene, polybutylene, polymethylpentane, ethylene-vinyl acetate copolymer, ethylene-ethyl acrylate copolymer, ethylene-acrylic acid copolymer, ethylene-methyl methacrylate copolymer, ethylene-α-olefin copolymer, ethylene-propylene copolymer, ethylene-butene copolymer, and the like, and combinations thereof.

Further, the thermoplastic resin which is miscible with the polyamide resin and has a weight average molecular weight of about 500,000 to about 5,000,000 should be stable under conditions of processing temperatures, which can range from about 260° C. to about 330° C. The acrylic resin or the sulfide resin are generally stable at high temperatures and thus can be used with no limitation; however, the polyolefin resin may degrade at a high temperature and, accordingly, a polyolefin resin with chains that are at least partially substituted with fluoroatoms (i.e., a fluorinated polyolefin resin) can be used.

The fluorinated polyolefin resin may be a conventionally available resin as known to the skilled artisan, and examples thereof include without limitation polytetrafluoroethylene, polyvinylidenefluoride, tetrafluoroethylene/vinylidenefluoride copolymers, tetrafluoroethylene/hexafluoropropylene copolymers, ethylene/tetrafluoroethylene copolymers, and the like, and combinations thereof.

Also, a modified acrylic copolymer including an aromatic acrylic compound, an alicyclic acrylic compound, or a combination thereof and a compound that is copolymerizable with the aromatic and/or alicyclic acrylic compound may be used as the acrylic resin above.

The terms “aromatic acrylic compound” and “alicyclic acrylic compound” refer to a (meth)acrylate compound substituted with an aromatic compound or alicyclic compound, respectively. The aromatic compound may include a substituted or unsubstituted C6 to C30 aryl compound or a substituted or unsubstituted C6 to C30 aryloxy compound, and the alicyclic compound may include a substituted or unsubstituted C3 to C30 cycloalkyl compound, a substituted or unsubstituted C3 to C30 cycloalkenyl compound, or a substituted or unsubstituted C3 to C30 cycloalkynyl compound. As used herein, unless otherwise defined, the term “substituted” refers to a group in which a hydrogen is substituted with halogen (F, Cl, Br, I), hydroxy, nitro, cyano, amino, carboxyl, C1 to C20 alkyl, C2 to C20 alkenyl, C2 to C20 alkynyl, C1 to C20 alkoxy, C6 to C30 aryl, C6 to C30 aryloxy, C3 to C30 cycloalkyl, C3 to C30 cycloalkenyl, C3 to C30 cycloalkynyl, or a combination thereof.

The compound that is capable of being copolymerized with the aromatic and/or alicyclic acrylic-based compound is a monofunctional unsaturated compound. Examples of the monofunctional unsaturated compound include without limitation alkyl methacrylates such as methyl methacrylate, ethyl methacrylate, propyl methacrylate, butyl methacrylate, and the like; alkyl acrylates such as methyl acrylate, ethyl acrylate, propyl acrylate, butyl acrylate, 2-ethylhexyl acrylate, and the like; unsaturated carboxylic acids such as acrylic acid, methacrylic acid, and the like; acid anhydrides such as maleic anhydride; (meth)acrylates having a hydroxyl group such as 2-hydroxyethylacrylate, 2-hydroxypropylacrylate, monoglycerolacrylate, and the like; amides such as acrylamide, methacrylamide, and the like; nitriles such as acrylonitrile, methacrylonitrile, and the like; epoxy group containing compounds such as allyl glycidylether, glycidylmethacrylate, and the like; aromatic vinyl compounds such as styrene, α-methylstyrene, and the like; and combinations thereof.

The modified acrylic copolymer may be a copolymer of about 20 wt % to about 99.9 wt % of the aromatic and/or alicyclic acrylic compound and about 0.1 wt % to about 80 wt % of the compound that is capable of being copolymerized therewith, for example about 40 wt % to about 80 wt % of the aromatic and/or alicyclic acrylic compound and about 20 wt % to about 60 wt % of the compound that is capable of being copolymerized therewith.

The polyamide resin composition of the invention includes the thermoplastic resin which is miscible with the polyamide resin and has a weight average molecular weight of about 500,000 to about 5,000,000 (D) in an amount of about 5 to about 80% by weight, based on the total weight of (A), (B), (C) and (D). In some embodiments, the polyamide resin composition may include the thermoplastic resin which is miscible with the polyamide resin and has a weight average molecular weight of about 500,000 to about 5,000,000 (D) in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80% by weight. Further, according to some embodiments of the present invention, the amount of the thermoplastic resin which is miscible with the polyamide resin and has a weight average molecular weight of about 500,000 to about 5,000,000 (D) can be in a range from about any of the foregoing amounts to about any other of the foregoing amounts.

(E) White Pigment

In the present invention, the whiteness of the polyamide resin composition can be achieved by including the heat conductive filler above; however, whiteness can also be achieved by further including a (C) white pigment. Examples of the (C) white pigment include without limitation titanium dioxide, zinc oxide, zinc sulfide, white lead, zinc sulfate, barium sulfate, calcium carbonate, aluminum oxide, and the like, and combinations thereof. These white pigments can be treated with a silane coupling agent or a titanium coupling agent. For example, the white pigments can be treated with a silane compound such as vinyltriethoxysilane, 2-aminopropyltriethoxysilane, 2-glycitoxypropyltriethoxysilane and the like, and combinations thereof. In exemplary embodiments, the white pigment includes titanium dioxide, which can improve reflectivity and block out properties. The titanium dioxide can be any conventional titanium dioxide and can have an average particle size of about 0.05 to about 2.0 μm, for example, about 0.05 to about 0.7 μm.

The polyamide resin composition of the invention can include the white pigment in an amount of about 0 to about 30 parts by weight, for example about 5 to about 30 parts by weight, based on the total weight of (A), (B), (C), and (D).

In some embodiments, the polyamide composition may not include the white pigment (E) (i.e., the polyamide resin composition may include 0 parts by weight of the white pigment (E)). In some embodiments, the white pigment (E) may be present in the polyamide resin composition, i.e., the polyamide resin composition may include the white pigment (E) in an amount of greater than and/or about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the white pigment (E) can be in a range from about any of the foregoing amounts to about any other of the foregoing amounts.

In exemplary embodiments of the present invention, the polyamide resin composition can have an initial whiteness index of more than about 89.

In other exemplary embodiments of the present invention, the polyamide resin composition can have a thermal conductivity of more than about 3.0 W/mK.

In other exemplary embodiments of the present invention, the polyamide resin composition can have a melt tensile strength of about 50 to about 150 cN based on 100 mm/s tensile velocity.

An Article Prepared from Polyamide Resin Composition

The present invention provides an article prepared from the polyamide resin composition above. The article can be, for example, a heat removal plate for a LED.

Further, the polyamide resin composition of the present invention can be a material for an integrated part for a LED including a reflector and a heat removal plate, since it has excellent whiteness, thermal conductivity and extrusion molding properties.

The invention is not limited to LED components, however, and the polyamide resin composition can be used in a variety of other products, such as but not limited to structural materials, automobile components, and the like.

The invention may be better understood by reference to the following examples which are intended for the purpose of illustration and are not to be construed as in any way limiting the scope of the present invention, which is defined in the claims appended hereto.

### Examples

The compounds used in Examples and Comparative Examples are as follows.

(A) Polyamide Resin

A polyamide resin including 100 parts by weight of dicarboxylic acid consisting of 60% by weight of terephthalic acid and 40% by weight of adipic acid and 100 parts by weight of 1,6-diaminohexane is used.

(B) Boron nitride is used to provide thermal conductivity and whiteness.

(C) Glass fiber is used as a filler.

(D) Polymethylmethacrylate having a weight average molecular weight of 1,250,000 is used as the thermoplastic resin which is miscible with the polyamide resin and has a weight average molecular weight of about 500,000 to about 5,000,000.

(E) Titanium dioxide is used as a white pigment.

Each polyamide thermoplastic resin (Examples 1-6, Comparative Examples 1-6) is prepared by mixing the compounds according to mixing ratios set forth in Table 1 below.

Thermal conductivity is measured according to ASTM E 1530.

Whiteness is measured according to ASTM E 313.

Melt tensile strength is measured by using a melt tension meter.

The results are set forth in the following Table 1.

TABLE 1

| | | | | | Polymethyl | | Thermal | |
|---|---|---|---|---|---|---|---|---|
| | | Boron | Titanium | Glass | Methacrylate | | conductivity | Melt tensile |
| | Polyamide | nitride | Dioxide | fiber | (PMMA) | Whiteness | (W/mK) | strength (cN) |
| Example 1 | 70 | 10 | 10 | 10 | 20 | 90 | 3.0 | 140 |
| Example 2 | 60 | 10 | 10 | 20 | 20 | 91 | 3.5 | 120 |
| Example 3 | 40 | 20 | 20 | 20 | 20 | 92 | 5.0 | 90 |
| Example 4 | 40 | 40 | | 20 | 10 | 91 | 10.0 | 65 |
| Example 5 | 30 | 50 | | 20 | 10 | 90 | 12.0 | 55 |
| Example 6 | 30 | 30 | 20 | 20 | 10 | 92 | 7.0 | 50 |
| Comparative | 90 | | | 10 | 20 | 86 | 0.2 | 175 |
| Example 1 | | | | | | | | |
| Comparative | 70 | | | 30 | 20 | 87 | 0.3 | 140 |
| Example 2 | | | | | | | | |
| Comparative | 30 | 60 | | 10 | 10 | 87 | 15.0 | 45 |
| Example 3 | | | | | | | | |
| Comparative | 30 | | 50 | 20 | 10 | 96 | 2.5 | 45 |
| Example 4 | | | | | | | | |
| Comparative | 40 | | 40 | 20 | 10 | 94 | 2.0 | 65 |
| Example 5 | | | | | | | | |
| Comparative | 70 | 10 | 10 | 10 | | 88 | 3.0 | 35 |
| Example 6 | | | | | | | | |

As represented in Table 1, Examples 1 to 6 of the invention show that efficient thermal conductivity, melt tensile strength and whiteness are achieved simultaneously as compared to the Comparative Examples.

Also, Comparative Examples 1 and 2 show that the compositions without titanium dioxide and boron nitride do not have both good thermal conductivity and whiteness. As for Comparative Examples 4 and 5, the compositions including only titanium dioxide without boron nitride do not have good thermal conductivity. Further, Comparative Example 3 shows that the compositions including an excess amount of boron nitride have a decreased whiteness. Comparative Example 6 show that when a basic resin including only polyamide is used, melt tensile strength decreases and, accordingly, extrusion molding properties also deteriorate.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A polyamide resin composition comprising:
(A) polyamide resin;
(B) heat conductive filler;
(C) filler; and
(D) thermoplastic resin which is miscible with the polyamide resin and has a weight average molecular weight of about 500,000 to about 5,000,000.

2. The polyamide resin composition of claim 1, wherein the (B) heat conductive filler comprises boron nitride, aluminum oxide, boron carbide, calcium fluoride, aluminum nitride, or a combination thereof.

3. The polyamide resin composition of claim 1, wherein the (D) thermoplastic resin which is miscible with the polyamide resin and has a weight average molecular weight of about 500,000 to about 5,000,000 comprises acrylic resin, sulfide resin, polyolefin resin, or a combination thereof.

4. The polyamide resin composition of claim 1, wherein the polyamide resin composition includes about 10 to about 80% by weight of the (A) polyamide resin, about 5 to about 55% by weight of the (B) heat conductive filler, about 5 to about 30% by weight of the (C) filler, and about 5 to about 80% by weight of the (D) thermoplastic resin which is miscible with the polyamide resin and has a weight average molecular weight of about 500,000 to about 5,000,000.

5. The polyamide resin composition of claim 1, wherein the polyamide resin composition further includes (E) white pigment.

6. The polyamide resin composition of claim 5, comprising the (E) white pigment in an amount of about 5 to about 30 parts by weight, based on 100 parts by weight of the polyamide resin composition comprising about 10 to about 80% by weight of the (A) polyamide resin, about 5 to about 55% by weight of the (B) heat conductive filler, about 5 to about 30% by weight of the (C) filler, and about 5 to about 80% by weight of the (D) thermoplastic resin which is miscible with the polyamide resin and has a weight average molecular weight of about 500,000 to about 5,000,000.

7. The polyamide resin composition of claim 1, having an initial whiteness index of more than about 89.

8. The polyamide resin composition of claim 1, having a thermal conductivity of the polyamide resin composition is more than 3.0 W/mK.

9. The polyamide resin composition of claim 1, wherein melt tensile strength of about 50 to about 150 cN based on 100 mm/s tensile velocity.

10. The polyamide resin composition of claim 1, wherein (A) the polyamide resin includes a main chain including a benzene ring prepared by condensation polymerization of a dicarboxylic acid monomer including about 10 to about 100% by weight of an aromatic dicarboxylic acid with an aliphatic diamine, alicyclic diamine, or a combination thereof.

11. The polyamide resin composition of claim 10, wherein (A) the polyamide resin is prepared by condensation polymerization of hexamethylenediamine and terephthalic acid.

12. The polyamide resin composition of claim 1, wherein (B) the heat conductive filler comprises boron nitride.

13. The polyamide resin composition of claim 1, wherein (C) the filler comprises glass fibers.

14. The polyamide resin composition of claim 1, wherein (C) the filler comprises needle shaped filler.

15. The polyamide resin composition of claim 1, wherein (D) the thermoplastic resin which is miscible with the polyamide resin and has a weight average molecular weight of about 500,000 to about 5,000,000 comprises polymethylmethacrylate resin.

16. The polyamide resin composition of claim 1, wherein (D) the thermoplastic resin which is miscible with the polyamide resin and has a weight average molecular weight of about 500,000 to about 5,000,000 comprises a modified acrylic copolymer including an aromatic acrylic compound, an alicyclic acrylic compound, or a combination thereof and a compound that is copolymerizable with the aromatic acrylic compound, alicyclic acrylic compound, or combination thereof.

17. The polyamide resin composition of claim 6, wherein (E) the white pigment comprises titanium dioxide.

18. The polyamide resin composition of claim 6, wherein the polyamide resin (A) comprises hexamethylenediamine and terephthalic acid; the heat conductive filler (B) comprises boron nitride, the filler (C) comprises glass fiber; the thermoplastic resin which is miscible with the polyamide resin and has a weight average molecular weight of about 500,000 to about 5,000,000 (D) comprises polymethylmethacrylate resin; and the white pigment (E) comprises titanium dioxide.

19. A method for producing a polyamide resin composition comprising mixing about 10 to about 80% by weight of a (A) polyamide resin, about 5 to about 55% by weight of a (B) heat conductive filler, about 5 to about 30% by weight of a (C) filler, and about 5 to about 80% by weight of a (D) thermoplastic resin which is miscible with the polyamide resin and has a weight average molecular weight of about 500,000 to about 5,000,000.

20. An article prepared from the polyamide resin composition of claim 1.

21. The article of claim 20, wherein the article is a heat removal plate for a LED.

22. The article of claim 20, wherein the article is an integrated part for a LED including a reflector and a heat removal plate.
